(19) United States
(12) Patent Application Publication
(10) Pub. No.: US 2009/0116137 A1
(43) Pub. Date: May 7, 2009

(54) Perpendicular magnetic recording medium and magnetic storage apparatus using the same

(76) Inventors: Ikuko Takekuma, Kanagawa (JP); Hiroaki Nemoto, Kanagawa (JP); Hiroyuki Nakagawa, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(21) Appl. No.: 12/288,598

(22) Filed: Oct. 21, 2008

(30) Foreign Application Priority Data
Nov. 6, 2007 (JP) 2007-288971

(51) Int. Cl. G11B 21/02; G11B 5/66

(52) U.S. Cl. 360/75; 428/831.2; 428/828; G9B/21.003; G9B/5.241

(57) ABSTRACT

Embodiments of the present invention provide a perpendicular magnetic recoding medium capable of decreasing exchange coupling between crystal grains while suppressing increase in the crystal grain size of the magnetic recording layer. According to one embodiment, a perpendicular magnetic recoding medium is formed by stacking a seed layer, an intermediate layer, a magnetic recording layer, and a protecting layer all above a substrate. The magnetic recording layer has a granular structure constituted of a plurality of columnar grains comprising a CoCrPt alloy and a grain boundary containing an oxide. The seed layer is formed by stacking a first seed layer, a second seed layer, and a third seed layer in which the first seed layer comprises Ti or Ti alloy having a hexagonal close-packed structure, the second seed layer comprises Cu, Ag, or Al having a face-centered cubic structure or an alloy containing at least one element selected therefrom, and the third seed layer comprises an Ni alloy having a face-centered cubic structure.

### CROSS-REFERENCE TO RELATED APPLICATION

The instant nonprovisional patent application claims priority to Japanese Patent Application No. 2007-288971 filed Nov. 6, 2007 and which is incorporated by reference in its entirety herein for all purposes.

### BACKGROUND OF THE INVENTION

In recent years, the amount of information handled by computers has increased, and a corresponding increase in the capacity of a hard disk unit as an auxiliary storage apparatus has been demanded. Further, with more hard disk units incorporated into home electronics products, demand for decreasing the size and increasing the capacity of the hard disk units has been growing, and a further improvement in recording density has been demanded. While hard disk units using a longitudinal recording system have attained an in-plane recording density exceeding 20 gigabits per 1 cm², it has become difficult to further improve the recording density by using that system, and a perpendicular recording system has thus been studied as a substitute system. The perpendicular recording system is less likely to suffer the effect of demagnetizing fields in a high-density recording region than the longitudinal recording system and is believed to be advantageous in increasing the recording density.

For the perpendicular magnetic recording media used for the perpendicular recording system, a magnetic recording layer comprising a CoCrPt alloy used for the longitudinal recording medium has been studied so far. However, for further decreasing noises, a granular-type magnetic recording layer formed of a CoCrPt alloy with oxygen or oxide added thereto has been proposed and attracted attention. The granular-type magnetic recording layer is disclosed, for example, in Japanese Unexamined Patent Publications No. 2001-222809 and 2003-178413. In the case of the conventional magnetic recording layer comprising the CoCrPt alloy, noise has been decreased by disproportionately concentrating a non-magnetic material mainly comprising Cr in the grain boundary, utilizing phase separation between Co and Cr, and by magnetically isolating magnetic crystal grains. For further reduction in the noise effect, it is necessary to add a large amount of Cr, but in that case, Cr remains in a large amount also in the magnetic crystal grains, which results in a problem that the magnetic anisotropic energy lowers, deteriorating the stability of recording signals. For overcoming such a problem and attaining low noise characteristics, a granular-type magnetic recording layer comprising the CoCrPt alloy with oxygen or oxide added thereto has been studied actively. For example, Japanese Patent Publication No. 2002-342908 (“Patent Document 1”) discloses a granular-type magnetic recording layer comprising a CoCrPt alloy with Si oxide added thereto. In the case of adding a large amount of the oxide as above, the crystal orientation of the magnetic recording layer deteriorate, or the oxide tends to intrude not only into the magnetic grain boundary but also into the magnetic crystal grains. As a result, the coercivity (Hc) and the squareness ratio decrease, resulting in the problem of a deteriorated medium S/N ratio.

For overcoming the problem described above, it is important to control fine structures such as the formed grain boundary, crystal orientation, and crystal grain size of the magnetic recording layer by an intermediate layer or a seed layer disposed below the magnetic recording layer, and various materials and structures have been studied so far. While most of them concern a method of controlling the fine structures by the change of the material or optimization of manufacturing conditions for the seed layer and the intermediate layer, a seed layer utilizing an insular structure formed at the initial film growth stage has been studied in recent years. For example, Japanese Patent Publication No. 2006-331582 (“Patent Document 2”) and Japanese Patent Publication No. 2005-190517 (“Patent Document 3”) describe perpendicular magnetic recording media using Ti as a first seed layer, Cu as a second seed layer, and Ru as an intermediate layer. Patent Documents 2 and 3 state that since these seed layers are those utilizing the insular growth of Cu on Ti, and the intermediate Ru layer grows in columnar form with Cu or Ti as a seed, the crystal grain size can be scaled down with satisfactory crystal orientation maintained.

While the crystal grain size of the magnetic recoding layer can be scaled down by forming an intermediate layer or a seed layer below the recording magnetic recording layer, the effect of decreasing the magnetization reversal unit is small since sufficient grain boundary width cannot be formed.

### BRIEF SUMMARY OF THE INVENTION

Embodiments of the present invention provide a perpendicular magnetic recoding medium capable of decreasing exchange coupling between crystal grains while suppressing increase in the crystal grain size of the magnetic recording layer. According to the embodiment of FIG. 1, a perpendicular magnetic recoding medium 10 is formed by stacking a seed layer, an intermediate layer, a magnetic recording layer, and a protecting layer all above a substrate 11. The magnetic recording layer has a granular structure constituted of a plurality of columnar grains comprising a CoCrPt alloy and a grain boundary containing an oxide. The seed layer is formed by stacking a first seed layer 14a, a second seed layer 14b, and a third seed layer 14c in which the first seed layer 14a comprises Ti or Ti alloy having a hexagonal close-packed structure, the second seed layer 14b comprises Cu, Ag, or Al having a face-centered cubic structure or an alloy containing at least one element selected therefrom, and the third seed layer 14c comprises an Ni alloy having a face-centered cubic structure.

### BRIEF DESCRIPTION OF THE DRAWINGS

FIG. 1 is a schematic cross-sectional view showing the layered structure of a perpendicular magnetic recording medium according to an example of an embodiment of the invention.

FIGS. 2(a) and 2(b) are schematic views showing the structure of a magnetic storage apparatus mounting thereon a perpendicular magnetic recording medium according to an embodiment the invention.

FIG. 3 is a schematic view showing the relation between a magnetic head and a perpendicular magnetic recording medium mounted on the magnetic storage apparatus shown in FIG. 2.

FIGS. 4(a), 4(b), and 4(c) are views of the recording section of the magnetic head as viewed from the opposite side of the medium.

FIG. 5 is a table showing the relation between the structure of a seed layer and the recording/reproducing characteristics.

FIG. 6 is a table showing the relation between the structure of a first seed layer and the recording/reproducing characteristics.

FIG. 7 is a table showing the relation between the composition of a second seed layer and its crystal structure.

FIG. 8 is a table showing the relation between the structure of a third seed layer and the recording/reproducing characteristics.

FIG. 9 is a table showing the relation between the composition of a third seed layer and its corrosion resistivity.

FIG. 10 is a table showing the relation between the composition of the third seed layer and the recording/reproducing characteristics.

FIG. 11 is a table showing the recording/reproducing characteristics in the narrow track head of a sample shown in FIG. 10.

FIGS. 12(a), 12(b), and 12(c) are graphs showing the relation between the thickness of a first seed layer and recording/reproducing characteristics.

FIGS. 13(a) and 13(b) are graphs showing the relation between the average thickness of the second seed layer and the recording/reproducing characteristics.

FIG. 14 is a graph showing the relation between the additive amount of W or V and medium S/N ratio of a third Ni-alloy seed layer.

FIG. 15 is a graph showing the relation between the thickness of the third seed layer and the medium S/N ratio.

### DETAILED DESCRIPTION OF THE INVENTION

Embodiments of the present invention relate to a magnetic recording medium capable of recording information of large capacity and a magnetic storage apparatus using the same.

The relation between the fine structures was investigated, such as the crystal grain size and the grain boundary width of the magnetic recording layer, and the medium S/N ratio with the use of the seed layer utilizing the insular structure formed at the initial stage of film growth described in the prior art and found that the effect of decreasing the magnetic cluster size (magnetization reversal unit) was small in the prior art due to its inability to form sufficient grain boundary width although the crystal grain size of the magnetic recording layer could be scaled down. As a result, a medium S/N ratio sufficient to attain a recording density exceeding 35 gigabits per 1 cm2 could not be obtained in the prior art.

Embodiments of the present invention have been made in view of the problem described above, and it an object to provide a perpendicular magnetic recoding medium capable of decreasing exchange coupling between crystal grains while suppressing increase in the crystal grain size of the magnetic recording layer, and having a high medium S/N ratio. Embodiments of the invention are further intended to provide a magnetic storage apparatus capable of high-density recording exceeding 35 gigabits per 1 cm² by utilizing a perpendicular magnetic recording medium having a high medium S/N ratio.

For attaining the objects described above, embodiments of the present invention provide a perpendicular magnetic recording medium having at least a seed layer, an intermediate layer, a magnetic recording layer, and a protecting layer stacked above a substrate, wherein the magnetic recording layer has a granular structure constituted of a plurality of columnar grains comprising a CoCrPt alloy and a grain boundary containing an oxide,
wherein the seed layer has a first seed layer, a second seed layer, and a third seed layer stacked sequentially, and
wherein the first seed layer comprises Ti or Ti alloy having a hexagonal close-packed structure, the second seed layer comprises one metal selected from Cu, Ag, Al, or Au having a face-centered cubic structure or an alloy containing one or more elements selected from Cu, Ag, Al, or Au, and the third seed layer comprises an Ni alloy having a face-centered cubic structure.

When the second seed layer comprising a metal selected from Cu, Ag, Al, or Au having a face-centered cubic lattice structure or an alloy containing one or more elements selected from Cu, Ag, Al, or Au is formed on the first seed layer comprising Ti or Ti alloy having a hexagonal close-packed structure, periodical surface irregularities can be obtained at the initial stage of film growth. This is because the initial growth stage of said second seed layer undergoes the three-dimensional insular growth due to the surface energy difference between said first seed layer and said second seed layer larger than the interface energy between the first and second seed layers.

The thickness of the first seed layer is preferably in the range from 3 nm to 10 nm. With that range, sufficient crystal orientation and recording magnetic field gradients can be obtained, and correspondingly a higher medium S/N ratio can also be obtained.

The average thickness of the second seed layer is preferably in the range from 0.5 nm to 3 nm. With that range, surface irregularities having short intervals and sufficient surface roughness (island with small grain size) can be formed by utilizing the insular structure found only in the initial thin-film growth stage of the second seed layer. Also, the adoption of the above thickness range promotes scaling-down of the crystal grain size of the third seed layer and the intermediate layer formed on the second seed layer and increase in layer surface roughness. As a result, magnetic isolation between the crystal grains of the magnetic recording layer can be promoted, resulting in a higher medium S/N ratio.

Further, the third seed layer is preferably W- or V-containing Ni alloy, W- or V-containing NiCr alloy, or an NiFe alloy containing one or more elements selected from W, V, Ta, or Nb. By the addition of W or V, an element with a high melting point, to Ni, NiCr alloy, or NiFe alloy of a face-centered cubic structure, surface roughness necessary for forming a clear grain boundary can be formed on the surface of the intermediate layer while enlargement of the crystal grain size associated with film growth is suppressed. As a result, the magnetic cluster size of the magnetic recording layer can be decreased, which results in a higher medium S/N ratio.

The intermediate layer is preferably selected from Ru, Ru alloy, and CoCr alloy. Selecting these materials for the intermediate layer improves the crystal orientation of the magnetic recording layer, whereby a high medium S/N ratio can be obtained. Further, the intermediate layer may have a structure in which a first intermediate layer and a second intermediate layer are stacked sequentially, and in which the first intermediate layer is formed of Ru and Ru alloy, the second intermediate layer is formed of an alloy formed by adding at least one kind of oxide selected from Si oxide, Ti oxide, Ta oxide, Cr oxide, or Al oxide to Ru, and the second intermediate layer is constituted of crystal grains comprising Ru as a main component and a grain boundary comprising an oxide and surrounding the crystal grains. Forming the second intermediate layer of the granular structure at the interface between the magnetic recoding layer and the intermediate layer as above can promote the formation of the grain boundary during the initial growth layer of the magnetic recording layer, thereby improving the medium S/N ratio.

Further, the magnetic recording layer may comprise a plurality of magnetic recording layers and may be configured such that a first magnetic recoding layer comprising a granular structure constituted of a plurality of columnar grains comprising a CoCrPt alloy and grain boundaries containing an oxide and a second magnetic recording layer including Cr with Co as its main component and not including an oxide are stacked.

For attaining the other object of embodiments of the invention, a magnetic storage apparatus according to embodiments of the invention has a magnetic recording medium, a medium driving section for driving the magnetic recording medium, a magnetic head for performing read/write operations on the magnetic recording medium, and a head driving section for positioning the magnetic head at a desired track position on the magnetic recording medium in which the perpendicular magnetic recording medium described above is mounted on the magnetic storage apparatus as the magnetic recording medium.

The recording section of the magnetic head is a single-pole type head having a main pole and an auxiliary pole disposed on the leading side in the track direction and has a trailing shield via a non-magnetic gap layer on the trailing side of the main pole in the track direction. Since the magnetic head with the shield not only effectively reduces the effective track width to be written onto the medium but also can increase the recording magnetic field gradient compared with a single-pole type head with no shield, it can also improve the medium S/N ratio. The magnetic head with the shield can obtain a particularly high medium S/N ratio when the magnetic recording layer includes a first magnetic recording layer of a granular structure constituted of a plurality of columnar grains comprising a CoCrPt alloy and grain boundaries containing an oxide and a second magnetic recording layer comprising Co as its main component, containing Cr, and not containing an oxide. Further, side shields are preferably provided on both sides of the main pole via a non-magnetic gap layer. In this case, the effect of reducing the effective track width to be written onto the medium can be improved further.

According to embodiments of the present invention, since the exchange coupling between crystal grains can be decreased with increase in the crystal grain size of the magnetic recording layer suppressed, a perpendicular magnetic recording medium having a high medium S/N ratio can be provided. Further, a magnetic storage apparatus capable of high-density recording exceeding 35 gigabits per 1 cm2 can be provided with the use of the perpendicular magnetic recording medium having a high medium S/N ratio.

The perpendicular magnetic recording medium according to an example of an embodiment of the invention was formed by a DC sputtering method using an in-line type sputtering apparatus.

The static magnetic characteristics of the magnetic recording layer were evaluated using a Kerr-effect-type magnetometer. The magnetic field was swept from −1592 KA/m to +1592 kA/m at a constant rate for 30 seconds in a direction perpendicular to the film surface to measure a Kerr loop.

The grain sizes of crystal grains were evaluated by the following method. The grain sizes were measured by observing the crystal grain images with the use of a transmission electron microscope and by analyzing their pictorial images. First, a magnetic recording medium specimen is cut out from the disk into an approximately 2-mm square to prepare a small slice. The small slice is polished to prepare an ultra-thin film which partially consists of only the magnetic recording layer and the protecting layer. The sliced sample is observed from the direction perpendicular to the substrate surface using the transmission type electron microscope, and bright-field crystal grain images are photographed. The bright-field images are those formed by shielding deflected electron beams by the objective diaphragm of the electron microscope and using only the electron beams not deflected. In the bright-field images of granular media, crystal grains appear as dark contrast portions due to their high deflection intensity, whereas grain boundaries can be separated distinctly as bright contrast portions due to their small deflection intensity. In these bright-field images, crystal grain images are obtained by drawing lines on the boundaries of the dark-contrast crystal grains. The obtained crystal grain images are then scanned by a scanner as digital data into a personal computer. The scanned image data are analyzed using commercial grain analysis software to determine the number of pixels constituting individual grains. Further, the areas of the individual grains are determined based on the scaling relation between the pixels and the real scale. The grain size is defined as the diameter of a circle having an area equivalent to the grain area determined above. The measurement was conducted for more than a hundred grains, and the average grain size is defined as the arithmetic mean calculated using the obtained grain sizes.

Next, the method of measuring the grain boundary width of the magnetic recording layer is described. The centroid of each grain is obtained by commercial grain analysis software. A line is drawn between the centroids of adjacent grains, and the length of the line present at the grain boundary portion is determined as the number of pixels. The length of the grain boundary portion is obtained by conversion of the obtained length into its real-scale length. The average grain boundary width is defined by averaging the lengths of more than a hundred gain boundaries.

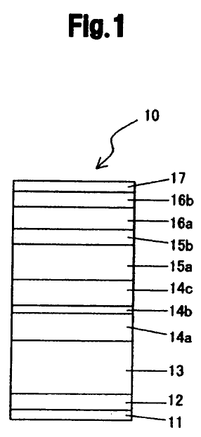

Embodiments of the present invention are described below with reference to the accompanying drawings. FIG. 1 is a cross-sectional view showing the layered structure of a perpendicular magnetic recording medium according to one embodiment of the invention. A perpendicular magnetic recording medium 10 is configured such that above a substrate 11, a pre-coating layer 12, a soft magnetic layer 13, a first seed layer 14a, a second seed layer 14b, a third seed layer 14c, a first intermediate layer 15a, a second intermediate layer 15b, a first magnetic recording layer 16a, a second magnetic recording layer 16b, and a protecting layer 17 are stacked sequentially in this order.

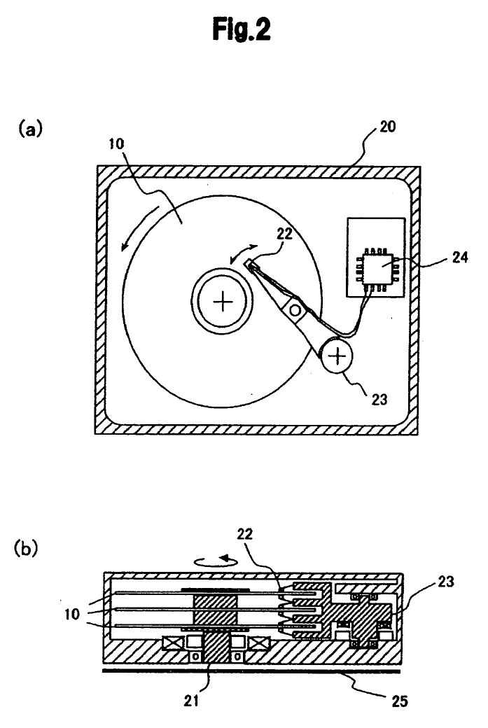

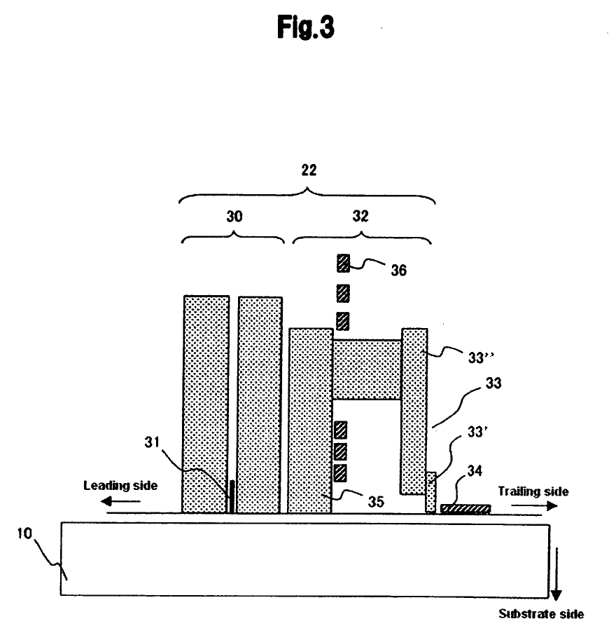

FIGS. 2(a) and 2(b) show schematic views of a magnetic storage apparatus mounting thereon a perpendicular magnetic recording medium according to an embodiment of the invention. FIG. 2(a) is a schematic plan view, and FIG. 2(b) is a schematic cross-sectional view thereof. The magnetic storage device 20 includes a magnetic recording medium 10, a driving section 21 for driving the magnetic recording medium, a magnetic head 22 comprising a recording section and a reproducing section, a head driving section 23 causing the magnetic head 22 to move relatively to the magnetic recording medium 10 and positioning the head at a desired track position, a pre-amplifier 24 for inputting and outputting signals to and from the magnetic head 22, and a circuit substrate 25 mounting thereon a control circuit for controlling the operation of the magnetic disk apparatus. FIG. 3 shows the relation between the magnetic head 22 and the magnetic recording medium 10. The reproducing section 30 has a reproducing device 31 sandwiched by a pair of magnetic shields, and a giant magnetoresistive device(GMR) or tunnel magnetoresistive device(TMR) is used for the reproducing device 31. The recording section 32 is a single-pole-type head having a main pole 33, an auxiliary pole 35, and a thin-film conductor coil 36. The main pole 33 includes a main pole end 33′ and a main pole yoke 33″, and a trailing shield 34 is formed on the trailing side of the main pole end 33′ in the track direction via a non-magnetic gap layer. Further, in addition to the magnetic head 22 shown in FIG. 3, a magnetic head having side shields on both sides of the main pole end 33′ in the directions of the track width via non-magnetic gap layers or a magnetic head with no shield can be used.

Described next with reference to Experimental Examples 1 to 7 are the composition, film thickness, and film forming conditions of each of the layers, and read/write characteristics of the perpendicular magnetic recording medium according to the exemplary embodiment shown in FIG. 1. The substrate 11 was not heated, and an Al-50 at. % Ti alloy film of 5-nm thickness was formed as the pre-coating layer 12 under the condition of a 0.7-Pa Ar gas pressure. An Fe-34 at. % Co-10 at. % Ta-5 at. % Zr alloy film with a total thickness of 30 nm was formed as the soft magnetic layer 13 on the pre-coating layer 12 under the condition of a 0.6-Pa Ar gas pressure. The soft magnetic layer 13 was formed such that two layers were ferromagnetically coupled via Ru. The seed layers shown in FIG. 5 were formed on the soft magnetic layer 13 under the condition of a 0.6-Pa Ar gas pressure. An Ru film of 6-nm thickness was formed as the first intermediate layer 15a on the seed layer comprising the plurality of layers under the condition of a 5.5-Pa Ar gas pressure, and then the second intermediate layer 15b comprising an Ru-Ti oxide of 1-nm thickness was stacked thereon. The second intermediate layer 15b was formed under the condition of a total gas pressure of 3 Pa, using an Ru-10 at. % Ti target and using an Ar gas mixed with 0.8% oxygen. Further, (Co-17 at. % Cr-18 at. % Pt)-8 mol % SiO₂ of 13.5-nm thickness was formed on the second intermediate layer 15b as the first magnetic recording layer 16a, and then a Co-15 at. % Cr-14 at. % Pt-8 at. % B alloy film of 4.5-nm thickness was formed as the second magnetic recording layer 16b not containing an oxide. Finally, a carbon film of 3.5-nm thickness was formed as the protecting layer 17. The first magnetic recording layer 16a containing an oxide was formed by using an Ar gas mixed with 4% oxygen and under the condition of a total gas pressure of 4 Pa. The second magnetic recording layer 16b not containing an oxide was formed under the condition of an Ar gas pressure of 0.6 Pa. The carbon protecting layer 17 was formed using an Ar gas mixed with 28% nitrogen and under the condition of a total gas pressure of 0.6 Pa.

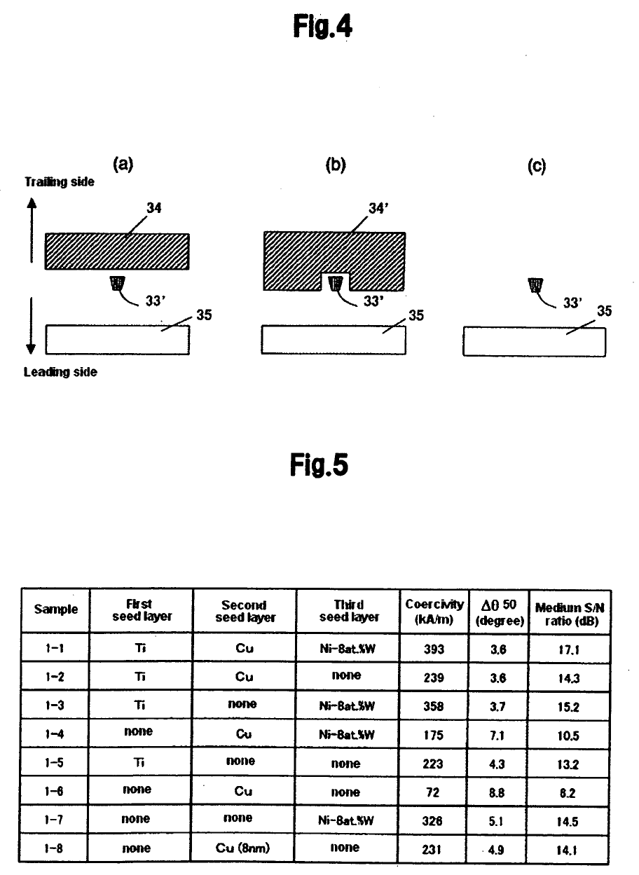

The magnetic head used for the evaluation of the recording/reproducing characteristics had the same structure as that of the magnetic head 22 explained in FIG. 3, and FIG. 4(a) is a view as observed from the side opposite to the medium. A perpendicular recording magnetic head with a shield in which the magnetic shield (trailing shield) 34 is disposed so as to cover the trailing side of the main pole 33 in the track direction via a non-magnetic gap layer was used for the structure of a general single-pole-type head including the main pole 33 and the auxiliary pole 35 disposed on the leading side in the track direction. This head is hereinafter referred to as a trailing shield head. Further, the width at the top end of the main pole 33 was 133 nm, and a giant magnetoresistive (GMR) reproducing device with an interelectrode space of 100 nm and a shield gap length of 45 nm was used as the reproducing device. The medium S/N ratio was obtained by the ratio of signal intensity S to integrated medium noises N when recording is performed at a linear recording density of 21653 fr/mm. Since the magnetic head with a shield not only more effectively reduces the effective track width to be written onto the medium than the single-pole-type head with no shield (FIG. 4C) but also can increase the recording magnetic field gradient, it has the effect of improving the medium SNR. It was reported that a perpendicular magnetic recording medium in which a second magnetic recording layer comprising a CoCr alloy not containing an oxide was stacked on a granular-type first magnetic recording layer comprising a CoCrPt alloy with an oxide added thereto as in this example can provide particularly excellent overwrite (O/W) characteristics and high medium S/N ratios when used in combination with a magnetic head with a shield.

### EXPERIMENTAL EXAMPLE 1

The evaluation results of the recording/reproducing characteristics in which various perpendicular magnetic recording media having mutually different seed-layer structure were used are explained below. FIG. 5 shows each sample's seed-layer structure, coercivity, full width at half maximum Δθ₅₀ of a rocking curve in Co (0004) diffraction measured by using an X-ray diffraction apparatus, and medium S/N ratio. The thickness of a Ti film used as the first seed layer was 8 nm, the average thickness of a Cu film used as the second seed layer was 1 nm, and the thickness of an Ni-8 at. % W film used as the third seed layer was 6 nm. However, the thickness of the Cu film of Sample 1-8 alone was 8 nm. In FIG. 5, Sample 1-1 represents the structure of the seed layer of the perpendicular magnetic recording medium 10 according to the example of this invention. FIG. 5 reveals that when Sample 1-1 and Sample 1-2 are compared, forming the third seed layer above the first and second seed layers as in Sample 1-1 increases the coercivity and medium S/N ratio.

For examining the change of the fine structure of the magnetic recording layer due to the insertion of the third seed layer, a sample having the same composition as those of Samples 1-1 and 1-2 and without the second magnetic recording layer not containing an oxide was formed, and the crystal grain size, the grain boundary width, and the variation of the crystal grain size in the magnetic recoding layer were analyzed using a transmission electron microscope (TEM). The reason that TEM observation was conducted for the sample comprising only the first magnetic recording layer is as follows. In the case of using a magnetic recording layer in which the second magnetic recording layer comprising a CoCr alloy not containing an oxide is stacked on the granular-type first magnetic recording layer as in this example, the medium S/N ratio is determined mainly by the granular-type magnetic recording layer containing an oxide, and the magnetic recording layer comprising the CoCr alloy not containing an oxide plays the auxiliary role of improving the O/W characteristics. Accordingly, it will be understood more easily when the first magnetic recording layers are compared in order to examine the relation between a magnetic recording medium and its medium S/N ratio.

The result of the analysis of TEM observation images showed that the crystal grain size of the first magnetic recording layer of Sample 1-2 without third seed layer was as small as 6.8 nm, but the grain boundary width was as small as 0.7 nm. In contrast, in the first magnetic recording layer of Sample 1-1, while the crystal grain size was 8.2 nm, larger than that of Sample 1-2, the grain boundary width was 1.1 nm, and a clear grain boundary was formed. Since Sample 1-2 caused larger transition noises than Sample 1-1, it appears that lower medium S/N ratios can be attributable to increased magnetic cluster size when the grain boundary width was not sufficient regardless of the scaled-down crystal grain size of the magnetic recording layer as in Sample 1-2. On the other hand, when the third seed layer is inserted as in Sample 1-1, the crystal grain size of the magnetic recording layer obtained by TEM analysis increases compared with Sample 1-2. This, however, allows for formation of a clear grain boundary. Thus, exchange coupling between the crystal grains can be decreased, and as a result, a high medium S/N ratio can be obtained. Further, when the variation of the crystal grain size was evaluated by the value obtained by dividing the standard deviation of the crystal grain size of each sample with the average crystal grain size, it was 18% in Sample 1-1 while 23% in Sample 1-2. Accordingly, it can be said that the third seed layer also has the effect of decreasing the variation of the crystal grain size.

Further, Sample 1-3 without the second seed layer showed a lower medium S/N ratio than that of Sample 1-1. When the fine structure of the first magnetic recording layer was analyzed by using the TEM in the same manner as in Samples 1-1 and 1-2, Sample 1-3 had a crystal grain size of 8.6 nm and the grain boundary width of 0.9 nm. In view of the foregoing, it seems that since the crystal grain size increased and the grain boundary width decreased in Sample 1-3 without second seed layer compared with Sample 1-1, the magnetic cluster size increased, and the medium S/N ratio was thus degraded. That is, it can be said that the second seed layer has the effect of promoting the formation of the grain boundary while suppressing the enlargement of the crystal grain size of the magnetic recording layer.

Further, Sample 1-4 without the first seed layer and Sample 1-6 without the first and third seed layers exhibited remarkably lower medium S/N ratios than that of Sample 1-1. Since the Δθ₅₀ values of these samples increased greatly, the lowered medium S/N ratios can be attributed mainly to drastically degraded crystal orientation. From the foregoing, it can be seen that the perpendicular magnetic recording medium according to the example of this embodiment of the invention having all the first, second, and third seed layers is most excellent in terms of the crystal orientation and the fine structure, and can provide a high medium S/N ratio.

Further, Sample 1-1 showed the highest medium S/N ratio of the remaining Samples 1-5, 1-7, and 1-8, in which the seed layer comprises one of the first, second, and third seed layers. When the fine structures of the first magnetic recording layers of these samples were analyzed using the TEM, they had crystal grain sizes ranging from 8.5 nm to 9 nm and grain boundary widths ranging from 0.7 to 0.9 nm. That is, it follows that when the seed layer comprised one of the first, second, and third seed layers, the medium S/N ratio was degraded since the crystal grain size was larger and the grain boundary width was smaller than that of Sample 1-1 having the first, second, and third seed layers.

Further, a first seed layer with the same structure as that of Sample 1-1 was formed, and the same layer was exposed for four seconds to a mixed gas atmosphere of argon and oxygen at an oxygen concentration of 0.3% in a sputtering chamber to perform surface oxidation treatment. Then, a second seed layer was formed thereon. In this case, a medium S/N ratio as high as 17.5 dB was obtained. It appears that magnetic isolation between the crystal grains was further promoted and the crystal grains were scaled down in the magnetic recording layer by conducting surface oxidation of the first seed layer, thus resulting in the higher medium S/N ratio.

The result shown in FIG. 5 was obtained in the same manner also in the case of evaluating the recording/reproducing characteristics by applying the magnetic head of FIG. 4B (hereinafter referred to as a trailing side shield head), in which the magnetic shield (trailing side shield) 34′ is disposed in the track width direction of the main pole and on the trailing side in the track direction via a non-magnetic gap layer, to the general structure of a single-pole-type head comprising a main pole and an auxiliary pole disposed on the leading side in the track direction. Further, the same result as in FIG. 5 was obtained also in the case of evaluating the same samples by using a head in which the distance between the main pole and the trailing shield of the trailing side shield head was changed in the range from 50 nm to 100 nm, or a head in which the shield height was changed in the range from 50 nm to 250 nm.

The effects obtained by the above example are not restricted by the types of substrates, and the material, the forming process, the thickness, etc. of the precoating layer, the soft magnetic layer, the intermediate layer, and the magnetic recording layer. For example, when the precoating layer is not used, when an FeCoB alloy is used as the soft magnetic layer, or when the density of the magnetic flux from the recording head can be maintained at a sufficient level, the soft magnetic layer may be eliminated. Further, as shown in the present example, in addition to the structure in which two soft magnetic layers are antiferromagnetically coupled by sandwiching an Ru layer between them and the magnetic flux is circulated in the soft magnetic layer, a structure in which an antiferromagnetic material such as an MnIr alloy is provided below the soft magnetic layer, thereby fixing the magnetization direction of the soft magnetic layer except during recording has also been known. Such a structure mainly has the effect of decreasing the noises attributable to the soft magnetic layer during reproduction.

The same effects as obtained by FIG. 5 are obtainable also by changing the thickness of Ru, that is, the first intermediate layer 15a, and a particularly profound effect was obtained when the thickness of the Ru layer was 10 nm or less. Since Ru is a rare metal element and an expensive material, the present example is effective in reducing the manufacturing costs. Further, the same effects were obtained also when the magnetic recording medium did not include the first or second intermediate layer, or when the second intermediate layer comprised an Ru—Si oxide, an Ru—Ta oxide, or a CoCr oxide. The same effects were also obtained in the following cases: when an Ru—Ta oxide of 0.7-nm thickness was formed as the second intermediate layer by using, for example, an Ru-10 at. % Ta target under the condition of a total gas pressure of 3 Pa using an Ar gas mixed with 0.8% oxygen; when Ru-8 mol/% SiO₂ was formed to 2-nm thickness; and when the intermediate layer comprised one layer, and a CoCr oxide was formed to 4-nm thickness as the intermediate layer by using a Co-40 at. % Cr target under the condition of a total gas pressure of 4 Pa using an Ar gas mixed with 12% oxygen.

Further, the same effects can be obtained also when the composition of the first recording layer is different. For example, the same effects can be obtained also in the case of using (Co-19 at % Cr-18 at. % Pt)-8 mol. % SiO₂, (Co-17 at. % Cr-18 at. % Pt)-9 mol. % SiO₂, (Co-15 at. % Cr-18 at. % Pt)-8 mol. % SiO₂, and (Co-12 at. % Cr-25 at. % Pt)-8 mol. SiO₂.

Further, the same effects can be obtained in the case of changing the concentration of the oxide to be mixed with the target to be used upon forming the first magnetic recording layer, or forming an oxide in the grain boundary of the recording layer only by the introduction of oxygen in the film-formation process without mixing the oxide. Further, the same effects can be obtained also in the case of replacing the Si oxides with another oxide, for example, a Ta oxide, Ti oxide, or Nb oxide. The same effects were obtained also in the case of using, for example, (Co-19 at. % Cr-16 at. % Pt)-2 mol. % Ta₂O₅ or (Co-19 at. % Cr-16 at. % Pt)-2 mol. % Nb₂O₅ as the first magnetic recoding layer. Still further, the same effects were obtained also in the case of using Co-12 at. % Cr-14 at. % Pt-10 at. % B of 5-nm thickness, using Co-14 at. % Cr-14 at. % Pt-10 at. % B of 5.5-nm thickness, or using Co-15 at. % Cr-16 at. % Pt-9 at. % B of 4.5-m thickness as the second magnetic recording layer. Further, the thickness and the composition of the second magnetic recording layer can be changed in accordance with the writing performance of the head. For example, in the case of combination with a head of low writing performance, the O/W characteristics can be improved by using the material at low Cr concentration and having high saturation magnetization (Ms) or increasing the thickness.

Further, the same effects were obtained also by inserting a coupling layer comprising a CoRu alloy, CoCr alloy, CoRuCr alloy, or a material formed by adding an oxide such as an oxide of Si, Ti, or Ta to one of these alloys between the first magnetic recording layer and the second magnetic recording layer in order to adjust the ferromagnetic coupling between the first magnetic recording layer and the second magnetic recording layer to preferred strength. The same result as in experimental Example 1 was obtained, for example, in the case of using a Co-40 at. % Ru alloy of 0.6-nm thickness as the coupling layer and a Co-13 at. % Cr-18 at. % Pt-7 at. % B of 3.5-nm thickness as the second magnetic recording layer, or in the case of using a (Co-27 at. % Cr)-8 mol. % SiO₂ alloy of 1.2-nm thickness as the coupling layer and a Co-13 at. % Cr-18 at. % Pt-7 at. % B of 3.2-nm thickness as the second magnetic recording layer.

### EXPERIMENTAL EXAMPLE 2

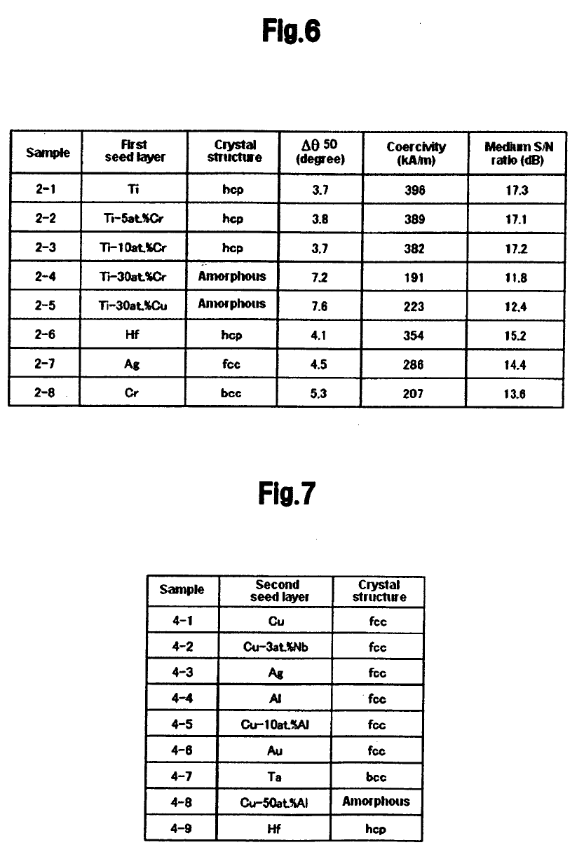

The perpendicular magnetic recording medium of Experimental Example 2 was formed with the same film structure and under the same film forming condition as those in Sample 1-1 of Experimental Example 1 except for the first seed layer and the third seed layer. In all of the samples of experimental Example 2, an Ni-10 at. % Cr-6 at. % W of 6-nm thickness was used as the third seed layer. In Experimental Example 2, the material of the first seed layer was changed. The thickness of the first seed layer was 8 nm in all of the samples. These samples were evaluated in the recording/reproducing characteristics by using the same trailing shield head as in Experimental Example 1. FIG. 6 shows the composition of the first seed layer, the crystal structure of the first seed layer, coercivity, the full width at half maximum Δθ₅₀ of a rocking curve in Co(0004) diffraction measured by using an X-ray diffraction apparatus, and the medium S/N ratio. Excellent characteristics were obtained particularly in the case of using Ti or a Ti alloy having a hexagonal close-packed (hcp) structure as the first seed layer as in Samples 2-1 to 2-3. Since these materials engage in strong interactions at the interface with the metal or the alloy having the face-centered cubic (fcc) structure used for the second seed layer, their wettability is satisfactory, and a strong (111) orientation is obtained. Further, due to the strong interactions at the interface, the movement and joining of islands upon three-dimensional insular growth during the initial growth stage are suppressed, which increases the density of the islands and decreases the lateral size of the islands. As a result, the crystal grain size of the third seed layer growing on the islands was scaled down, which supposedly resulted in a high SNR ratio. On the other hand, in the case of using a Ti alloy having an amorphous structure such as Ti-30 at. % Cr or Ti-30 at. % Cu as in Samples 2-4 and 2-5, the crystal orientation was degraded remarkably, resulting in remarkably degraded medium S/N ratios as shown in FIG. 6. Further, the medium S/N ratio was all degraded compared with Samples 2-1 to 2-3 in the case of using Hf even with the hcp structure as in Sample 2-6, in the case of using a material of the fcc structure as in Sample 2-7, and in the case of using a material of a body-centered cubic (bcc) structure as in Sample 2-8. Since the coercivity was lowered, and the value Δθ₅₀ increased in each of the samples (Samples 2-4 to 2-8) compared with Samples 2-1 to 2-3, the reduced medium S/N ratios can be attributed to degraded crystal orientation and to insufficiency of magnetic isolation in the magnetic recording layer. In view of the foregoing, it is desired that the material be selected from Ti or a Ti alloy having the hcp structure for the first seed layer in order to obtain a high medium S/N ratio.

The result of FIG. 6 was also obtained in the same manner in the case of evaluating the recording/reproducing characteristics by using a trailing side shield head. The same result as in FIG. 6 was obtained also in the case of evaluating the same samples using a head in which the distance between the main pole and the trailing shield of the trailing side shield head was changed in the range from 50 nm to 100 nm or a head in which the shield height was changed in the range from 50 nm to 250 nm.

### EXPERIMENTAL EXAMPLE 3

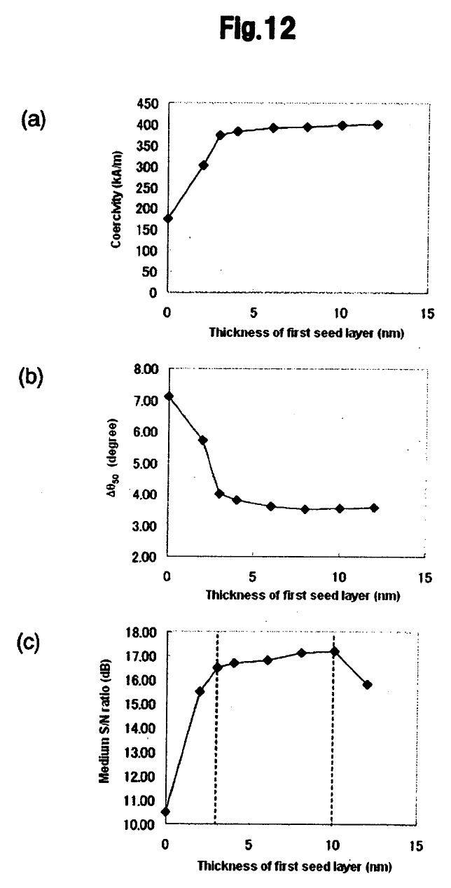

The samples of Experimental Example 3 were formed with the same film structure and under same film forming condition as those in Sample 1-1 of Experimental Example 1 except for the first seed layer. In the samples of Experimental Example 3, the thickness of the first seed layer was changed. The samples were evaluated in the recording/reproducing characteristics using the same type trailing shield head as that of Experimental Example 1. FIGS. 12(a), 12(b), and 12(c) show the measured coercivity (Hc), the full width at half maximum Δθ₅₀ of a rocking curve in Co (0004) diffraction measured with an X-ray diffraction apparatus, and the medium S/N ratio, respectively. As shown in FIGS. 12(a) and (b), particularly excellent crystal orientation and high coercivity were obtained when the thickness of the Ti film was more than 3 nm. However, as shown in FIG. 12(c), while particularly high medium S/N ratios were obtained at a Ti thickness of 3 nm or more correspondingly to the high values of Δθ₅₀ and coercivity, the medium S/N ratio was degraded when the thickness of Ti was increased to more than 10 nm. In this case, the recording resolution was also degraded greatly by increasing the Ti thickness from 10 nm to 12 nm. That is, the degraded medium S/N ratio when the seed layer thickness was more than 10 nm seems to be attributable to the increased effect of the degradation of the recording magnetic field gradient. The above results substantiate the necessity to set the thickness of the first seed layer in the range from 3 nm to 10 nm. When the layer thickness is in that range, sufficient crystal orientation and a sufficient recording magnetic field gradient can be obtained, whereby a higher medium S/N ratio can also be obtained.

The result of FIGS. 12(a)-12(c) was also obtained in the same manner in the case of evaluating the recording/reproducing characteristics using the trailing side shield head. Further, the same result as in FIGS. 12(a)-12(c) was obtained also in the case of evaluating the same samples using a head in which the distance between the main pole and the trailing shield of the trailing side shield head was changed in the range from 50 nm to 100 nm or a head in which the shield height was changed within the range from 50 nm to 250 nm.

### EXPERIMENTAL EXAMPLE 4

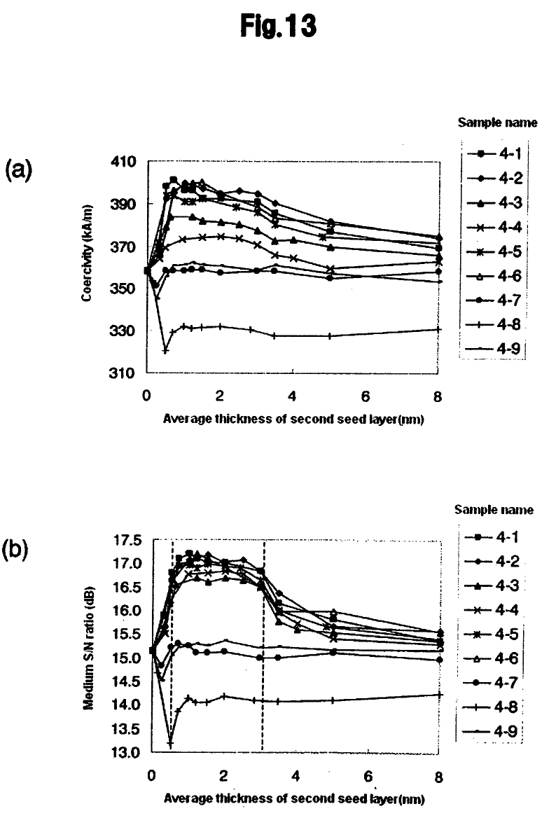

The samples of Experimental Example 4 were formed with the same film structure and under the same film forming condition as those in Sample 1-1 of Experimental Example 1 except for the second seed layer. In the samples of Experimental Example 4, the material and the thickness of the second seed layer were changed. FIG. 7 shows the material and the crystal structure of the second seed layer of Experimental Example 4. FIG. 13(a) shows the relation between the coercivity and the average thickness of the second seed layer, and FIG. 13(b) shows the evaluation result of the recording/reproducing characteristics using the same trailing shield head as that of Experimental Example 1. As in Samples 4-1 to 4-6, when the second seed layer comprises a metal selected from Cu, Ag, Al, or Au having the fcc structure, or an alloy containing at least one element selected from Cu, Ag, Al, or Au, a particularly high coercivity and high medium S/N ratio were obtained when the average thickness of the second seed layer was in the range from 0.5 nm to and 3 nm. When the average thickness of the second seed layer is less than 0.5 nm, an insular structure with uniform and sufficient surface roughness is less likely to be formed; correspondingly, the magnetic isolation of the crystal grains of the magnetic recording layer is less likely to occur. Thus, both the coercivity and the medium S/N ratio are low. Further, when the second seed layer is not present (similarly to Sample 1-3 of Experimental Example 1), the magnetic cluster size is large due to increased crystal grain size and decreased grain boundary width as mentioned in Experimental Example 1, thus degrading the medium S/N ratio. Further, when the average thickness of the second seed layer exceeds 3 nm, since the surface roughness due to the insular structure formed at the initial film growth stage decreases, the magnetic isolation of the crystal grains of the magnetic recoding layer is also less likely to occur. Further, as the result of analyzing the fine structure of the magnetic recoding layer using the TEM, when the average thickness of the second seed layer exceeded 3 nm, the crystal grain size of the magnetic recording layer tended to grow as large as 10 nm or larger. In contrast, when the average thickness of the second seed layer is in the range from 0.5 nm to 3 nm, a clear grain boundary of more than 1 nm width can be formed with a crystal grain size less than 10 nm. That is, when the average thickness of the second seed layer is in the range from 0.5 nm to 3 nm, exchange coupling of the crystal grains of the magnetic recording layer can be decreased without enlarging the crystal grain size, and a high medium S/N ratio can be obtained.

Further, as in Samples 4-7 and 4-9, in the case of using Ta having the bcc structure or Hf having the hcp structure as the second intermediate layer, change of the coercivity and the medium S/N ratio along with increase in the average thickness of the second seed layer is slight, and the effect of decreasing the exchange coupling of the grain boundary of the magnetic recording layer was scarcely observed. Further, as in Sample 4-8, in the case of using Cu-50 at. % Al having the amorphous structure as the second seed layer, the coercivity and the SNR decreased along with increase in the thickness of the second seed layer irrespective of the use of the same CuAl alloy as that of Sample 4-5.

In view of the foregoing result, the use of the following second seed layer is preferable: a layer comprising a metal selected from Cu, Ag, Al, or Au or an alloy containing at least one element selected from Cu, Ag, Al, or Au, having the average film thickness from 0.5 nm to 3 nm, and having the fcc structure, not the bcc structure, the hcp structure, or the amorphous structure. The use of the above second seed layer allows for a higher medium S/N ratio because surface irregularities having uniform and sufficient surface roughness can be formed and because the scaling-down and magnetic isolation of the crystal grains of the magnetic recording layer can be promoted.

The result of FIG. 13 was also obtained in the same manner in the case of evaluating the recording/reproducing characteristics using the trailing side shield head. The same result as in FIG. 13 was obtained also in the case of evaluating the same samples using a head in which the distance between the main pole and the trailing shield of the trailing side shield head was changed within the range from 50 nm to 100 nm or a head in which the shield height was changed within the range from 50 nm to 250 nm.

### EXPERIMENTAL EXAMPLE 5

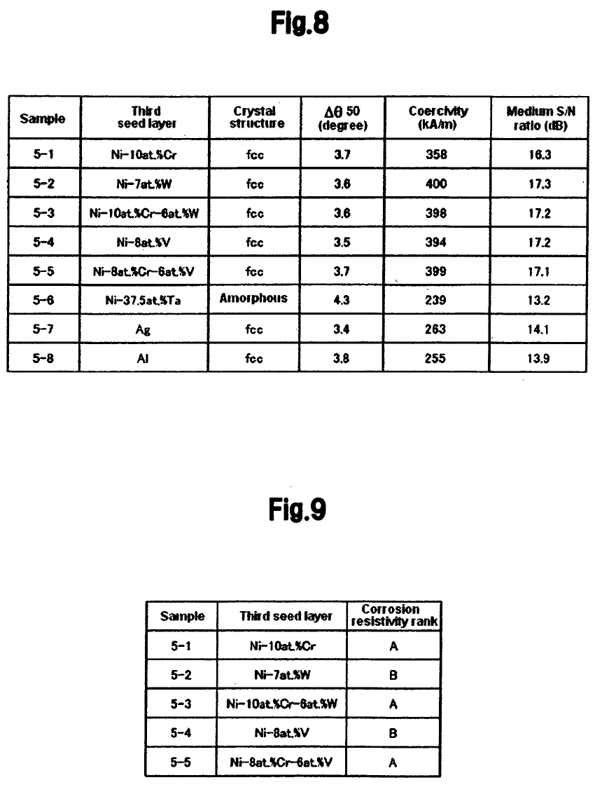

Perpendicular magnetic recording media of Experimental Example 5 were formed with the same film structure and under the same film forming condition as those in Sample 1-1 of Experimental Example 1 except for the third seed layer. In Experimental Example 5, the material of the third seed layer was changed. The thickness for the third seed layer was fixed to 6 nm. These samples were evaluated in the recording/reproducing characteristics using the same trailing shield head as that of Experimental Example 1. FIG. 8 shows the third seed layer's material, crystal structure, coercivity (Hc), full width at half maximum Δθ₅₀ of a rocking curve in Co (0004) diffraction measured with an X-ray diffraction apparatus, and medium S/N ratio. A particularly high medium S/N ratio can be obtained with Samples 5-1 to 5-5 using an Ni alloy having the fcc structure as the third seed layer. On the other hand, the medium S/N ratio lowered in Sample 5-6 using Ni-37.5 at. % Ta having an amorphous structure although this was an Ni alloy, and in Samples 5-7 and 5-8 using Ag or Al having the fcc structure. Representative samples among the ones described above were analyzed in the fine structure of the first magnetic recoding layer using the TEM in the same manner as in Experimental Example 1. While Sample 5-3 high in medium S/N ratio had a crystal grain size of 8.1 nm and a grain boundary width of 1.1 nm, Sample 5-6 low in medium S/N ratio had a crystal grain size of 7.6 nm and a grain boundary width of 0.6 nm, and Sample 5-6 had a crystal grain size of 8.8 nm and a grain boundary width of 0.7 nm. Thus, the effect of promoting the formation of a grain boundary of the magnetic recording layer is higher in the case of using the Ni alloy having the fcc structure for the third seed layer than in the case of using Ni-37.5 at. % Ta having the amorphous structure or using Ag or Al having the fcc structure. It appears that as a result of the use of the former structure, the magnetic cluster size can be decreased, and a high medium S/N ratio can be obtained.

When Samples 5-1 to 5-5 are compared, it can be seen that Samples 5-2 to 5-5 with an addition of W or V show particularly higher medium S/N ratios than that of Sample 5-1. Representative samples among those mentioned above were analyzed in the fine structure of the first magnetic recording layer using the TEM in the same manner as in Experimental Example 1. Sample 5-1 had a crystal grain size of 9.2 nm and a grain boundary width of 0.7 nm, and the variation of the crystal grain size (value obtained by dividing the standard deviation of the crystal grain size with an average value) was calculated to be 24%. On the other hand, as described above, Sample 5-3 had a crystal grain size of 8.1 nm and a grain boundary width of 1.1 nm, and the variation of the crystal grain size was determined as 17%. Thus, it can be said that adding W or V having a high melting temperature to the Ni alloy of the face-centered cubic structure as the third seed layer enables the formation of a clear grain boundary while suppressing enlargement of crystal grain size and variation of the grain size associated with film growth. As a result, a higher medium S/N ratio can be obtained.

Next, the corrosion resistivity of Samples 5-1 to 5-5 was evaluated in the following manner. First, the samples were left for 96 hours in a high-temperature and high-humidity state at a temperature of 60° C. and at a relative humidity of 90% RH or more. Then, the number of corroded points within the radial range from 14 mm to 25 mm was counted with an optical surface analyzer, and the samples were ranked in the following manner. Those with a count less than 50 ranked as A; those with a count within the range from 50 to 200 ranked as B; those with a count within the range from 200 to 500 as C; and those with a count greater than 500 as D. From a practical point of view, a rank equal to or greater than B is desirable. FIG. 9 shows the evaluation result of corrosion resistivity. While each of the samples ranked as B or higher, Samples 5-1, 5-3 and 5-5 with an addition of Cr exhibited excellent rank-A corrosion resistivity. That is, a perpendicular magnetic recording medium with a high medium S/N ratio and excellent corrosion resistivity can be obtained with the use of the NiCrW alloy or NiCrV as the third seed layer.

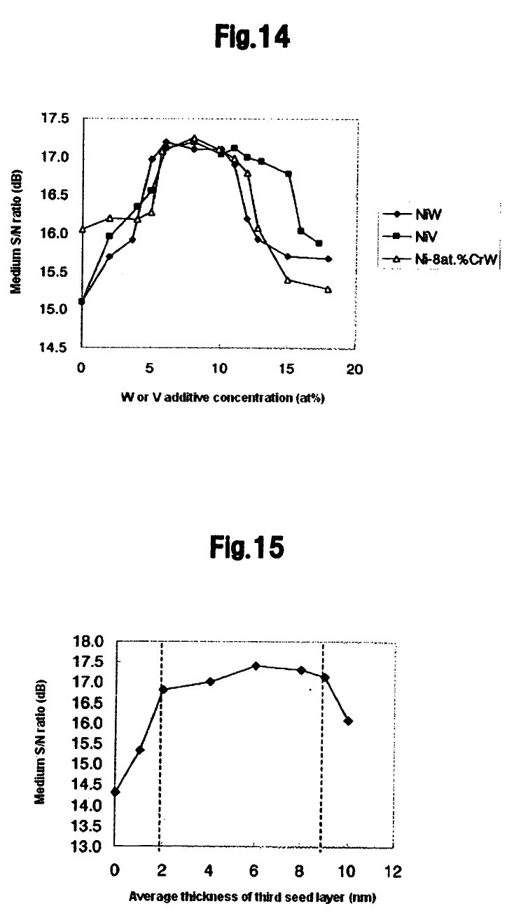

Next, the concentration of W or V added to the NiW, NiV, and NiCrW alloys that exhibited particularly excellent medium S/N ratios in FIG. 8 was changed to create samples with various composition, and FIG. 14 shows the measurement result on their medium S/N ratios. In the NiCrW alloy, the Cr concentration was fixed to 8 at. %, and the additive concentration of W was changed. As shown in FIG. 14, particularly high medium S/N ratios were obtained with the NiW alloy containing W within the range from 6 at. % to 11 at. %, with the NiV alloy containing V within the range from 5 at. % to 15 at. %, and with the Ni-8 at. % CrW alloy containing W within the range from 6 at. % to 12 at. %. As a result of examining the magnetic characteristics of only the third seed layer regarding the composition of low additive concentration of W or V that exhibited a relatively low medium S/N ratio, it was confirmed that ferromagnetic components appeared. In the case of the head used in Experimental Example 5, the magnetic flux density from the recording head is sufficient, and the seed layer possessing ferromagnetism between the magnetic recording layer and the soft magnetic layer constitutes a noise source. For this reason, the medium S/N ratio may have degraded. Further, when the additive concentration of W or V was high, the full width at half maximum Δθ₅₀ of a rocking curve in Co (0004) diffraction measured with an X-ray diffraction apparatus showed a large value of 4.3° or greater. On the other hand, it was 3.7° for Ni-8 at. % Cr-6 at. % V that exhibited a relatively high medium S/N ratio. When W or V is added excessively, the crystal orientation deteriorate, which also degrades the medium S/N ratio. The same tendency as shown in FIG. 14 was also observed in the case of using Ni-5 at. % Cr—W, Ni-10 at. % Cr—W, Ni-12 at. % Cr—W, Ni-20 at. % Cr—W, Ni-5 at. % Cr—V, Ni-10 at. % Cr—V, and Ni-15 at. % Cr—V.

The result of Experimental Example 5 was also obtained in the same manner in the case of evaluating the recording/reproducing characteristics using the trailing side shield head. The same result as in Experimental Example 5 was obtained also in the case of evaluating the same samples using a head in which the distance between the main pole and the trailing shield of the trailing side shield head was changed within the range from 50 nm to 100 nm or a head in which the shield height was changed within the range from 50 nm to 250 nm.

### EXPERIMENTAL EXAMPLE 6

Perpendicular magnetic recording media of Experimental Example 6 were formed with the same film structure and under the same film forming condition as those in Sample 1-1 of Experimental Example 1 except for the third seed layer. Ni-7 at. % Cr-6 at. % W was used as the third seed layer, and the thickness of the third seed layer was changed. FIG. 15 shows the evaluation result on the recording/reproducing characteristics of the samples using the same trailing shield head as that of Experimental Example 1. Higher medium S/N ratios were obtained when the third seed layer was in the range from 2 nm to 9 nm. As a result of analyzing the fine structure of the first magnetic recording layer using the TEM in the same manner as in Experimental Example 1, when the third seed layer was in the range from 2 nm to 9 nm, the grain boundary width of the magnetic recording layer showed a value of 1 nm or more, and the variation of the crystal grain size was 20% or less. On the other hand, in the case of a 10-nm thick third seed layer, in which the medium S/N ratio decreased compared with the case where the third seed layer was in the range from 2 nm to 9 nm, the grain boundary width decreased to 0.9 nm, and the variation of crystal grain size increased to 24%. Accordingly, the thickness of the third seed layer is preferably in the range from 2 nm to 9 nm.

The result of FIG. 15 was also obtained in the same manner in the case of evaluating the recording/reproducing characteristics using the trailing side shield head. The same result as in FIG. 15 was obtained also in the case of evaluating the same samples using a head in which the distance between the main pole and the trailing shield of the trailing side shield head was changed within the range from 50 nm to 100 nm or a head in which the shield height was changed within the range from 50 nm to 250 nm.

### EXPERIMENTAL EXAMPLE 7

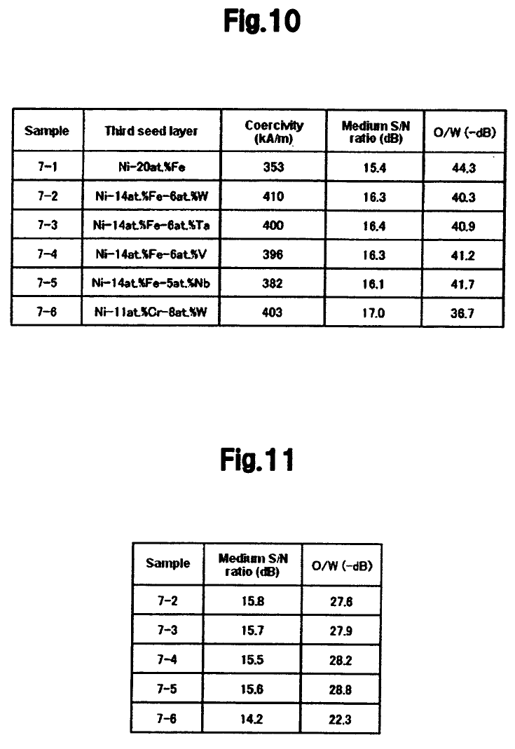

Perpendicular magnetic recording media of Experimental Example 7 were formed with the same film structure and under the same film forming condition as those in Sample 1-1 of Experimental Example 1 except for the third seed layer. In Samples 7-1 to 7-5 of Experimental Example 7, a permalloy material having the fcc structure was used as the material for the third seed layer, and its composition was changed. The thickness of the third seed layer was fixed to 7 nm. These samples were evaluated in the recording/reproducing characteristics using the same trailing shield head as that of Experimental Example 1 having a main pole width of 133 nm. FIG. 10 shows the third seed layer's material, coercivity (Hc), medium S/N ratio, and O/W characteristics. The O/W characteristics were evaluated with the use of the intensity ratio of the remaining components of a signal at a recording density of 21653 fr/mm to a signal at 4094 fr/mm after the signal at 4094 fr/mm was overwritten onto the signal at 21653 fr/mm. Paying attention to the change of the coercivity reveals that higher coercivity was obtained in Samples 7-2 to 7-5 in which W, V, Ta, or Nb was added to the NiFe alloy, than that of Sample 7-1 using Ni-20 at. % Fe. In the same manner as in Experimental Example 5, addition of W, V, Ta, or Nb seems to provide the effect of forming a clear grain boundary while suppressing the enlargement of crystal grain size and variation of the crystal grain size associated with film growth. When combined with the magnetic head used for the evaluation, all of the media exhibited excellent O/W characteristics of −30 dB or less. Further, when the medium S/N ratios of Samples 7-1 to 7-5 were compared, Samples 7-2 to 7-5 showed high medium S/N ratios corresponding to the change of the coercivity than that of Sample 7-1. However, in the case of combination with a head from which sufficient O/W characteristics can be obtained, Samples 7-2 to 7-5 showed low medium S/N ratios than that of Sample 7-6 using Ni-11 at. % Cr-8 at. % W not having ferromagnetism as the third seed layer, as shown in FIG. 10.

Next, the recording/reproducing characteristics of Samples 7-2 to 7-6 were evaluated using a trailing shield head with a main pole width of 70 nm. In the case of using such a head with small main pole width, while the track width can be decreased, sufficient O/W characteristics are difficult to obtain. FIG. 11 shows the medium S/N ratio and the O/W characteristics. When evaluation was conducted using the trailing shield head with the main pole width as small as 70 nm, while Sample 7-6 showed insufficient O/W characteristics, −25 dB or higher, Samples 7-2 to 7-5 exhibited improved O/W characteristics and high medium S/N ratios compared with Sample 7-6. In the case of recording with a magnetic head of small main pole width as above, from which sufficient O/W characteristics cannot be obtained, the use of a permalloy material to which W, V, Ta, or Nb is added for the third seed layer as in Samples 7-2 to 7-5 allows for improvement in the O/W characteristics and a higher medium S/N ratio. The result of Experimental Example 7 was obtained in the same manner also in the case of evaluating the recording/reproducing characteristics using the trailing side shield head.

Next, the magnetic storage apparatus mounting thereon the perpendicular magnetic recording medium 10 according to the examples of embodiments of the invention described above is explained with reference to FIG. 2, FIG. 3 and FIG. 4(b). As the perpendicular magnetic recording medium 10, the medium of Sample 5-3 in Experimental Example 5 was used. The flying height of the magnetic head 22 was set to 4 nm, a tunnel magnetoresistive device (TMR) was used for the reproducing device 31 of the reproducing section 30, the shield gap length was set to 50 nm, and the reproducing track width was set to 50 nm. A trailing side shield 34′ is provided around the main pole 33′ of the recording section 32 so as to cover the track width direction and the trailing side in the track direction via a non-magnetic gap layer, as shown in FIG. 4B. The geometric track width at the top end of the main pole was 80 nm, the distance between the main pole and the trailing shield was 50 nm, and the distance between the main pole and the side shield was set to 80 nm. Operation of the magnetic storage apparatus at 35.7 gigabits per 1 cm² could be confirmed by defining the track density per 1 cm as 78740 tracks and the linear recording density per 1 cm as 452756 bits.

What is claimed is:

1. A perpendicular magnetic recording medium comprising:
a substrate;
a seed layer;
an intermediate layer;
a magnetic recording layer; and
a protecting layer, the seed layer, the intermediate layer, the magnetic recording layer, and the protecting layer stacked above the substrate;
wherein the magnetic recording layer has a granular structure comprising a plurality of columnar grains comprising a CoCrPt alloy and a grain boundary including an oxide,
wherein the seed layer has a first seed layer, a second seed layer, and a third seed layer stacked sequentially, and
wherein the first seed layer comprises Ti or a Ti alloy having a hexagonal close-packed structure, the second seed layer comprises one metal selected from Cu, Ag, Al, or Au having a face-centered cubic structure or an alloy containing at least one element selected from Cu, Ag, Al, or Au, and the third seed layer comprises an Ni alloy having a face-centered cubic structure.

2. A perpendicular magnetic recording medium according to claim 1, wherein the thickness of the first seed layer is in the range from 3 nm to 10 nm.

3. A perpendicular magnetic recording medium according to claim 1, wherein the average thickness of the second seed layer is in the range from 0.5 nm to 3 nm.

4. A perpendicular magnetic recording medium according to claim 1, wherein the thickness of the third seed layer is in the range from 2 nm to 9 nm.

5. A perpendicular magnetic recording medium according to claim 1, wherein the thickness of the first seed layer is in the range from 3 nm to 10 nm, the average thickness of the second seed layer is in the range from 0.5 nm to 3 nm, and the thickness of the third seed layer is in the range from 2 nm to 9 nm.

6. A perpendicular magnetic recording medium according to claim 1, wherein the third seed layer comprises an Ni alloy containing W or V.

7. A perpendicular magnetic recording medium according to claim 1, wherein the third seed layer comprises an NiCr alloy containing W or V.

8. A perpendicular magnetic recording medium according to claim 1, wherein the third seed layer is an NiFe alloy containing at least one element selected from W, V, Ta, or Nb.

9. A perpendicular magnetic recording medium according to claim 1, wherein an oxide layer is present on the surface of the first seed layer.

10. A perpendicular magnetic recording medium according to claim 1, wherein the intermediate layer has a first intermediate layer and a second intermediate layer stacked sequentially, the first intermediate layer comprises Ru or an Ru alloy, and the second intermediate layer comprises an alloy formed by adding at least one kind of oxide selected from Si oxide, Ti oxide, Ta oxide, Cr oxide, or Al oxide to Ru and is constituted of crystal grains comprising Ru as a main component and grain boundaries comprising an oxide and surrounding the crystal grains.

11. A perpendicular magnetic recording medium according to claim 1, wherein the thickness of the first intermediate layer is 10 nm or less.

12. A perpendicular magnetic recording medium according to claim 1, wherein a soft magnetic layer is present between the substrate and the seed layer.

13. A perpendicular magnetic recording medium according to claim 1, wherein the magnetic recording layer comprises a plurality of magnetic recording layers and includes a first magnetic recoding layer of a granular structure constituted of a plurality of columnar grains comprising a CoCrPt alloy and a grain boundary including an oxide and a second magnetic recoding layer comprising Co as a main component, containing Cr, and not containing an oxide.

14. A magnetic storage apparatus comprising:
a magnetic recording medium;
a medium driving section for driving the magnetic recoding medium;
a magnetic head for performing read/write operations on the magnetic recoding medium; and
a head driving section for positioning the magnetic head at a desired track position on the magnetic recoding medium,
said magnetic recording medium being a perpendicular magnetic recording medium having a seed layer, an intermediate layer, a magnetic layer, and a protecting layer all stacked above a substrate;
wherein the magnetic recording layer has a granular structure constituted of a plurality of columnar grains comprising a CoCrPt alloy and a grain boundary including an oxide,
wherein the seed layer has a first seed layer, a second seed layer, and a third seed layer stacked sequentially, and
wherein the first seed layer comprises Ti or a Ti alloy having a hexagonal close-packed structure, the second seed layer comprises one metal selected from Cu, Ag, Al, or Au having a face-centered cubic structure or an alloy containing at least one element selected from Cu, Ag, Al, or Au, and the third seed layer comprises an Ni alloy having a face-centered cubic structure.

15. A magnetic storage apparatus according to claim 14, wherein the recording section of the magnetic head is a single-pole-type head having a main pole and an auxiliary pole disposed on the leading side in a track direction and has a trailing shield via a non-magnetic gap layer on the trailing side of the main pole in the track direction.

16. A magnetic storage apparatus according to claim 15, wherein the recording section of the magnetic head further includes side shields via a non-magnetic gap layer on both sides of the main pole in the track width direction.
